(19) United States
(12) Patent Application Publication
(10) Pub. No.: US 2020/0079134 A1
(43) Pub. Date: Mar. 12, 2020

(54) ANTI-COUNTERFEITING SHEET USING VISUAL CHARACTERISTICS ACCORDING TO VIEWING ANGLE, DIRECTION, AND DISTANCE, AND MANUFACTURING METHOD AND RECOGNITION METHOD THEREFOR

(71) Applicant: KOREA MINTING, SECURITY PRINTING & IDCARD OPERATING CORP., Daejeon (KR)

(72) Inventors: Han Sol YOO, Daejeon (KR); Hyuk Won LEE, Daejeon (KR); Jeong Woo HAN, Seoul (KR)

(73) Assignee: KOREA MINTING, SECURITY PRINTING & IDCARD OPERATING CORP., Daejeon (KR)

(21) Appl. No.: 16/490,581

(22) PCT Filed: Mar. 2, 2018
(86) PCT No.: PCT/KR2018/002525

§ 371 Date: Sep. 2, 2019

(30) Foreign Application Priority Data
Mar. 3, 2017 (KR) 10-2017-0027762

(51) Int. Cl. B42D 25/378; G06K 9/00; B42D 25/41; B42D 25/47; B42D 25/425; B41M 3/14

(52) U.S. Cl. CPC B42D 25/378; G06K 9/00577; B41M 3/14; B42D 25/47; B42D 25/425; B42D 25/41

(57) ABSTRACT

The present invention provides: an anti-counterfeiting sheet in which first and second patterns are formed as a plurality of elements and blanks on both surfaces of a transparent substrate and are to be visually recognized through the blanks, such that, by means of an optical illusion according to a viewing angle, direction, and distance, the resolution of the patterns changes or the colors thereof change, or the patterns develop or a pattern shift occurs; and a manufacturing method therefor. According to the present invention, high anti-counterfeiting effects such as a color shift, a latent image, and a security window can be obtained without using an expensive special ink, carrying out a complicated printing process, or using a special material. In addition, authenticity can be easily identified by carrying out photography at a specific viewing angle, direction, and distance with a smartphone and the like.

### CROSS-REFERENCE TO RELATED APPLICATION

This application is a U.S. national phase application of PCT International Application PCT/KR2018/002525, filed Mar. 2, 2018, which claims priority to Korean Patent Application No. 10-2017-0027762, filed Mar. 3, 2017, the contents of which are incorporated herein by reference in their entirety.

### TECHNICAL FIELD

The present invention relates to an anti-counterfeiting sheet using visual characteristics according to a viewing angle, direction, and distance, and a manufacturing method and recognition method therefor. More particularly, the present invention relates to an anti-counterfeiting sheet and a manufacturing method therefor, in which a color shift, a latent image, and a security window can be implemented at low cost using ordinary inks and printing rather than special inks or processes, whereby the resolution of patterns changes or the colors thereof change, or the patterns develop or a pattern shift occurs. In addition, the present invention relates to a method of recognizing authenticity of the manufactured anti-counterfeiting sheet with a smartphone.

### BACKGROUND ART

A variety of security effects, such as a watermark, hidden lines, a security window, and a latent image, are applied to an anti-counterfeiting sheet. The silver is one of the important security elements implemented in security paper to obtain the anti-counterfeiting effect of the sheet. In general, a part where less light is transmitted is seen dark and a part where much light is transmitted is seen brighter due to the difference in the thickness and density of the paper or fiber, so that the silver shape is implemented to be changed or developed. As a method of implementing the silver, Korean Patent No. 10-1213208 discloses a method of manufacturing silver using a laser. In addition, a number of techniques are known in which the pattern is developed or discolored at a specific light or a specific temperature by using a special ink, such as a variety of thermochromic or photochromic inks. Korean Patent No. 10-0824286 discloses a technique related to transfer paper using discoloration characteristics.

The latent image technology is generally a technique that allows different types of images to be visually recognized (viewed) according to the viewing angle by adjusting the line width or the shape of the lines formed by intaglio printing or forming the shape. Japanese Laid-Open Patent Publication No. 2009-214304 discloses a technique of forming a latent image pattern by performing printing on a raised pattern. In addition, there is used an effect of making the colors look different depending on the viewing angle using a special time-varying ink.

Herein, the anti-counterfeiting effects described above have a problem in that the material cost is high or the manufacturing process, such as using expensive special inks of thermochromic, photochromic, or time-varying inks, using intricate processes such as intaglio printing, using a special fiber material, or injecting a special effect in the sheet manufacturing stage, is complicated.

### SUMMARY

The present invention has been made in order to solve the above problems, and it is an objective of the present invention to provide an anti-counterfeiting sheet using visual characteristics according to a viewing angle, direction, and distance and a manufacturing method therefor, by which a color shift, a latent image, and a security window can be implemented at low cost using ordinary inks and flat printing rather than special inks or complicated processes such as intaglio printing, so that the resolution of patterns changes or the colors thereof change, or the patterns develop or a pattern shift occurs. In addition, the present invention is to obtain a stronger anti-counterfeiting effect with a fluorescent latent image and color shift effects depending on the viewing angle by using fluorescent ink. In addition, the present invention provides a method of easily recognizing authenticity of the manufactured anti-counterfeiting sheet with a smart phone.

In order to achieve the above object, according to an embodiment of the present invention, there is provided an anti-counterfeiting sheet including a transparent substrate having a first pattern formed on one surface and a second pattern formed on the other surface, wherein the first pattern is configured to include a plurality of first elements and first blanks, and the second pattern is configured to include a plurality of second elements and second blanks; and all or a part of the first element is hidden by the second element when the second element is viewed directly from above, and the first pattern is visually recognized at a predetermined viewing angle through the second blanks.

In order to achieve the above object, according to another embodiment of the present invention, there is provided an anti-counterfeiting sheet including: a first substrate having a first pattern formed on one surface; and a transparent substrate having one surface laminated with the one surface on which the first pattern of the first substrate is formed and the other surface on which a second pattern is formed, wherein the first pattern is configured to include a plurality of first elements and first blanks, and the second pattern is configured to include a plurality of second elements and second blanks; and all or a part of the first element is hidden by the second element when the second element is viewed directly from above, and the first pattern is visually recognized at a predetermined viewing angle through the second blanks.

The anti-counterfeiting sheet may further include a third pattern formed on the other surface opposite to the one surface on which the first pattern of the first substrate is formed, wherein the third pattern is configured to include a plurality of third elements and third blanks, and the first pattern is visually recognized at a predetermined viewing angle through the third blanks.

The plurality of first elements or second elements may be regularly arranged.

A resolution of the first pattern may change, a color thereof may change, the pattern may develop, or a pattern shift may occur according to a viewing angle, direction, and distance.

The transparent substrate may be composed of one or more layers having a predetermined light transmittance.

The first element may include sub-elements formed of different colors, different shapes, or different inks from each other.

The plurality of second elements may be formed using a plurality of inks having different amounts of reflectance from each other.

The first pattern or second pattern may be formed by a combination of any one or more of gravure printing, screen printing, flexographic printing, offset printing, inkjet printing, and deposition.

The first substrate and the second substrate may be laminated using an adhesive of a material having a predetermined light transmittance.

Embossed areas may be formed on the transparent substrate.

A protective layer or a background layer may be formed on one surface or both surfaces of the anti-counterfeiting sheet.

In order to achieve the above object, according to another embodiment of the present invention, there is provided a method of recognizing authenticity of the anti-counterfeiting sheet according to claim 1 or claim 2 with a user terminal having an App and a camera, in which the first pattern is designed to include an identification pattern, the method including: by the App, receiving an image of the anti-counterfeiting sheet through the camera; and by the App, detecting the authenticity by detecting the identification pattern from the received image, wherein the user terminal includes information about the identification pattern in advance.

In addition, according to another embodiment of the present invention, there is provided a program stored on a computer-readable recording medium for carrying out the method according to claim 13.

In addition, according to another embodiment of the present invention, there is provided a computer-readable recording medium having recorded thereon a program for executing the method according to claim 13.

In order to achieve the above object, according to another embodiment of the present invention, there is provided a method of manufacturing an anti-counterfeiting sheet, the method including: forming a first pattern on one surface of a transparent substrate; and forming a second pattern on the other surface of the transparent substrate, wherein the first pattern is configured to include a plurality of first elements and first blanks, and the second pattern is configured to include a plurality of second elements and second blanks; and all or a part of the first element is hidden by the second element when the second element is viewed directly from above, and the first pattern is visually recognized at a predetermined viewing angle through the second blanks.

In order to achieve the above object, according to another embodiment of the present invention, there is provided a method of manufacturing an anti-counterfeiting sheet, the method including: forming a first pattern on one surface of a first substrate; laminating a transparent substrate on the one surface on which the first pattern of the first substrate is formed by thermally compressing a coating layer or a film or via an adhesive; and forming a second pattern on the other surface opposite to one surface of the transparent substrate in contact with the first substrate, wherein the first pattern is configured to include a plurality of first elements and first blanks, and the second pattern is configured to include a plurality of second elements and second blanks; and all or a part of the first element is hidden by the second element when the second element is viewed directly from above, and the first pattern is visually recognized at a predetermined viewing angle through the second blanks.

The forming of the first pattern or the forming of the second pattern may include forming a third pattern on the other surface opposite to the one surface on which the first pattern of the first substrate is formed, and the third pattern may be configured to include a plurality of third elements and third blanks, and the first pattern is visually recognized at a predetermined viewing angle through the third blanks.

According to an embodiment of the present invention, it is possible to obtain color shift, latent image, and security window effects that first and second patterns are formed as a plurality of elements and blanks on both surfaces of a transparent substrate and are to be visually recognized through the blanks so that the resolution of the patterns changes or the colors thereof change, or the patterns develop or a pattern shift occurs by means of an optical illusion according to a viewing angle, direction, and distance. Therefore, high anti-counterfeiting effect is possible without using expensive special ink, complicated printing process, or special material. Therefore, the present invention is easy to use in a low-cost product family or small quantity multi-product family.

In addition, it is possible to obtain a stronger anti-counterfeiting effect with a fluorescent latent image and color shift effects depending on the viewing angle by using fluorescent ink.

In addition, since the security window effect according to the present invention easily adjusts colors seen on both sides of the transparent substrate the same or differently, it is possible to obtain a strong anti-counterfeiting effect.

In addition, there is an effect that authenticity can be easily identified by carrying out photography at a specific viewing angle, direction, and distance with a smartphone and the like.

### DESCRIPTION OF DRAWINGS

FIG. 1 is a view showing a cross-section and a plane of an anti-counterfeiting sheet utilizing visual characteristics according to a viewing angle, direction, and distance, according to an embodiment of the present invention.

FIG. 2 is a view showing a cross section and a plane of an anti-counterfeiting sheet utilizing visual characteristics according to a viewing angle, direction, and distance according to another embodiment of the present invention.

FIG. 3 is a view showing a cross section and a plane of an anti-counterfeiting sheet utilizing visual characteristics according to a viewing angle, direction, and distance according to another embodiment of the present invention.

FIG. 4 is a plan view of a first element printed on an anti-counterfeiting sheet utilizing visibility characteristics according to a viewing angle, direction, and distance according to another embodiment of the present invention.

FIG. 5 is a view showing a cross section and a plane of an anti-counterfeiting sheet utilizing visual characteristics according to a viewing angle, direction, and distance according to another embodiment of the present invention.

FIG. 6 is a view illustrating a cross section and a plane of an anti-counterfeiting sheet utilizing visibility characteristics according to a viewing angle, direction, and distance according to another embodiment of the present invention.

FIGS. 7 to 9 are cross-sectional views of an anti-counterfeiting sheet utilizing visual characteristics according to a viewing angle, direction, and distance according to another embodiment of the present invention.

FIG. 10 is a view showing a cross section and a plane of an anti-counterfeiting sheet utilizing visual characteristics according to a viewing angle, direction, and distance according to another preferred embodiment of the present invention.

FIG. 11 is a view showing visual characteristics from both sides of an anti-counterfeiting sheet utilizing visual characteristics according to a viewing angle, direction, and distance according to another preferred embodiment of the present invention.

FIG. 12 shows plan views of the first and second elements printed on an anti-counterfeiting sheet utilizing visual characteristics according to a viewing angle, direction, and distance according to another preferred embodiment of the present invention.

FIG. 13 is a plan view showing an anti-counterfeiting sheet utilizing visual characteristics according to a viewing angle, direction, and distance according to another embodiment of the present invention.

FIG. 14 is a view showing that an anti-counterfeiting sheet is visually recognized at a specific viewing angle, direction, and distance according to another embodiment of the present invention.

FIGS. 15 and 16 are views showing the anti-counterfeiting sheet is visually recognized at a specific viewing angle, direction, and distance according to another embodiment of the present invention.

FIG. 17 is a view showing that the anti-counterfeiting sheet according to the present invention is applied to the credit card.

FIGS. 18 and 19 are a diagram and a flowchart showing a method of recognizing authenticity of the anti-counterfeiting sheet with a user terminal, according to another embodiment of the present invention.

FIGS. 20 to 22 are flowcharts illustrating a method of manufacturing an anti-counterfeiting sheet utilizing visibility characteristics according to a viewing angle, direction, and distance, according to another embodiment of the present invention.

### DETAILED DESCRIPTION OF EXEMPLARY EMBODIMENTS

Hereinafter, embodiments of the present invention will be described in detail with reference to the accompanying drawings so that those skilled in the art may easily implement the present invention. In the following description, only parts necessary for understanding the operation according to the embodiment of the present invention are shown and described, and illustrations and descriptions of other parts are omitted so as not to obscure the subject matter of the present invention. As those skilled in the art would realize, the described embodiments may be modified in various different ways, all without departing from the spirit or scope of the present invention.

In addition, the terms or words used in the specification and claims described below are not to be construed as being limited to the conventional or dictionary meanings, and should be interpreted as meanings and concepts that match the technical spirit of the present invention to best express the present invention.

Throughout the specification, when a portion is said to “include” a certain component, this means that it can further include other components, without excluding the other component unless specifically otherwise stated.

In addition, the printing or forming of the pattern or element on the substrate throughout the specification is not limited to the typical printing method of printing by applying the ink, but includes a method of forming various patterns, such as a method of chemically/physically depositing a fine metal component.

For simplicity of description, although one or more methods are shown and described herein as a series of steps, for example in the form of a flowchart, it will be appreciated that the invention is not limited by the order of the steps, because the methods may be performed in a different order or simultaneously with other steps than shown and described herein in accordance with the present invention. Moreover, not all illustrated steps may have to implement a methodology in accordance with the present invention.

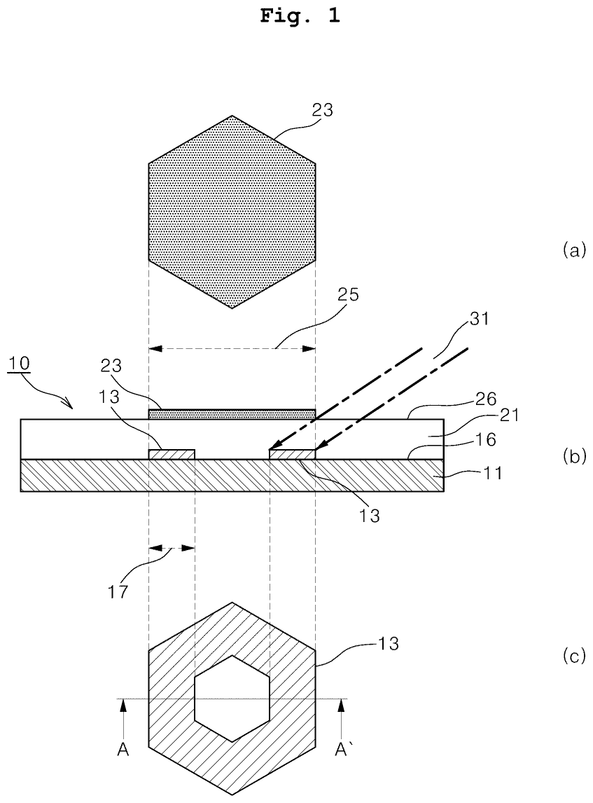

FIG. 1 is a view showing a cross-section and a plane of an anti-counterfeiting sheet 10 utilizing the visual characteristics according to a viewing angle, direction, and distance, according to an embodiment of the present invention, in which (a) is a plan view of a second element 23, (b) is a cross-sectional view of the anti-counterfeiting sheet 10, and (c) is a plan view of a first element 13.

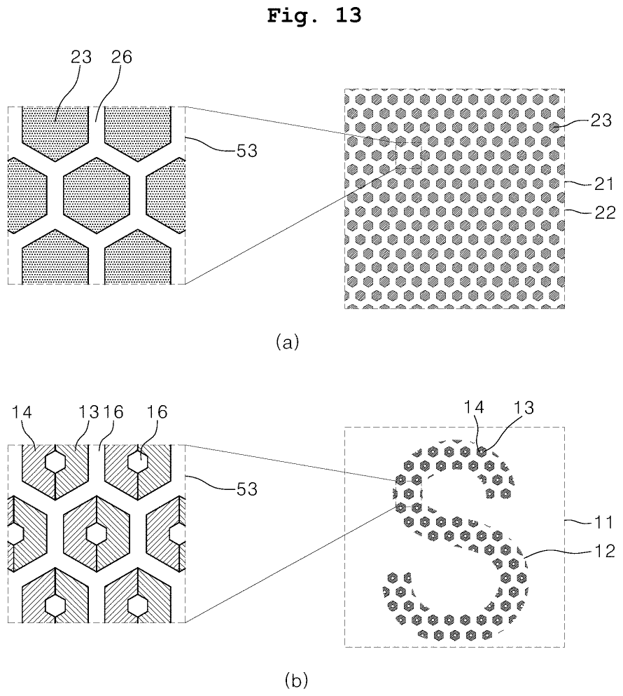

Referring to FIG. 1, the anti-counterfeiting sheet 10 is configured to include a first substrate 11 on which the first element 13 is printed and a second substrate (transparent substrate) 21 on which the second element 23 is printed. Referring to FIG. 13, the first pattern 12 is composed of a plurality of first elements 13 and first blanks 16, and the second pattern 22 is composed of a plurality of second elements 23 and second blanks 26, which will be described in detail with reference to FIG. 13.

As the first substrate 11, a typical paper substrate or a polymer substrate may be used, but the present invention is not necessarily limited thereto. In addition, as the first substrate 11, a transparent substrate, a substrate having a predetermined light transmittance, or an opaque substrate may be used according to the usage.

The second substrate 21 is a transparent substrate having a predetermined light transmittance, the substrate being a general coating layer substrate or formed by thermally compressing a film substrate. As the coating layer or the film, a transparent material is preferably used, and as the film, a polymer material is preferably used, but the present invention is not necessarily limited thereto.

In FIG. 1, the second substrate (transparent substrate) 21 is illustrated as a single transparent layer, but various substrates having light transmittance different from each other may be configured with several layers.

When the first and second substrates 11 and 21 are formed of a substrate having a predetermined light transmittance, it is possible to obtain a security window effect.

The first element 13 may be printed on one surface of the first substrate 11. Referring to FIG. 1, a cross-sectional view (b) and a plan view (c) of the first element 13 are shown together, in which the first element 13 is composed of two parts on one surface of the first substrate 11 as shown in the cross-sectional view (b), which is shown via a cross-section taken along a line A-A′ in the plan view (c) of the first element 13.

The second element 23 may be printed on the other surface opposite to a lamination surface of the second substrate 21. Referring to FIG. 1, a cross-sectional view (b) and a plan view (a) of a second element 23 are shown together.

The first element 13 or the second element 23 may be polygonal or circular shaped and, more preferably, regular hexagon or circle shaped, but the present invention is not necessarily limited thereto. More preferably, a regular hexagon can be used, because there are advantages that the pattern (first element or second element) may be recognized in multiple directions, and many patterns may be arranged per unit area in comparison to a circular shape. The number of patterns per unit area is highly related to the size of the pattern to be shown and the distance to be recognized. Details thereof will be described with reference to FIG. 13.

The first blank 16 indicates a portion in which the first element 13 is not printed on the printing surface of the first substrate 11.

The second blank 26 indicates a portion where the second element 23 is not printed on the printing surface of the second substrate 21.

The first element 13 and the second element 23 may be disposed and printed together with the blanks 16 and 26 when being printed on the first substrate 11 and the second substrate 21, respectively. Through these blanks, it is possible to obtain the optical illusion effect to be described in FIG. 13.

When the anti-counterfeiting sheet 10 is viewed directly from above (in a vertical direction from above the second substrate 21 or the second element 23), the first element 13 is hidden (or shielded) by the second element 23. This is because the first element 13 and the second element 23 are the same as each other in the pattern width 25.

Herein, when the anti-counterfeiting sheet 10 is viewed from the side at a specific viewing angle 31, the second element 13 is visually recognized (seen). That is, when viewed from the side at a specific viewing angle 31 through the second blank 26, the first element 13 is visually recognized through the transparent substrate 21. The first element 13 may be seen from the outside by the width 17 shown in FIG. 1.

The visual-recognition effect may be variously adjusted according to the thickness or density of the second substrate 21.

There is an unprinted area inside the first element 13, which may be an invisible area when viewed from the side at a specific viewing angle 31. Since this area is an area not visible from the outside, it is not necessary to print the area, but the present invention is not necessarily limited thereto. However, it is preferred that the width 17 illustrated be printed or designed.

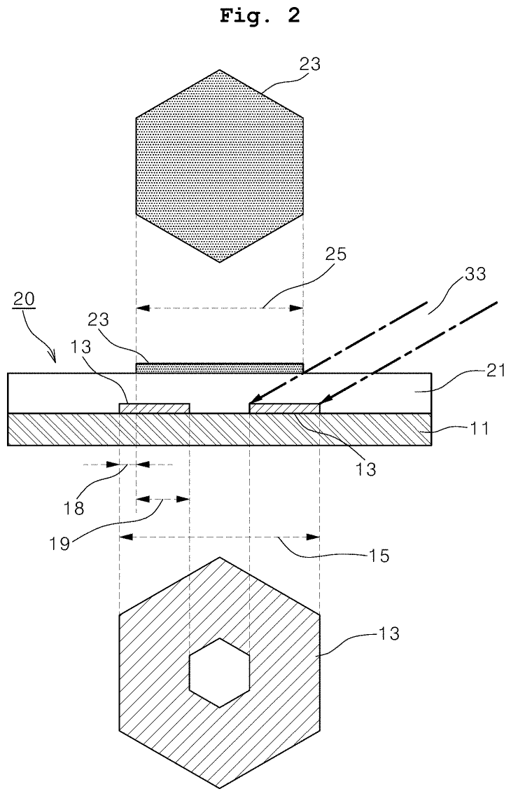

FIG. 2 is a view showing a cross section and a plane of an anti-counterfeiting sheet 20 utilizing visual characteristics according to a viewing angle, direction, and distance according to another embodiment of the present invention. Referring to FIG. 2, only the differences from FIG. 1 will be described.

FIG. 2 differs from FIG. 1 in that a pattern width 15 of the first element 13 is larger than a pattern width 25 of the second element 23, and a thickness of a second substrate 21 is larger. Two differences are to increase the visibility of the first element 13. To improve the visibility, two differences may be implemented at the same time, or only one of two may be implemented.

In the case of the anti-counterfeiting sheet 10 shown in FIG. 1, when the anti-counterfeiting sheet 10 is viewed directly from above (in a vertical direction from above), the first element 13 is completely hidden by the second element 23 and thus not seen. This is because the pattern width 25 of the first element 13 and the second element 23 is the same.

However, in the case of the anti-counterfeiting sheet 20 shown in FIG. 2, when looking down the anti-counterfeiting sheet 10 (the second substrate 21) from above, a part 18 of the first element 13 is seen. The reason thereof is to increase the visibility when the thickness of the second substrate 21 is thin.

Also, when the visibility is less as the second substrate 21 is thicker, the hidden element is more visible when viewed from the side at a specific viewing angle 33, so that the width 19 in FIG. 2 may be greater than the width 17 in FIG. 1.

Therefore, by increasing the pattern width 15 and the widths 18 and 19 of the first element 13 and increasing the thickness of the second substrate 21, it is possible to improve the visibility at a specific viewing angle.

However, when the partial width 18 is too large, the first element 13 is exposed too much to hinder security. Therefore, each width 15, 17, 18, and 19 is preferably adjusted according to the use or application purpose of the anti-counterfeiting sheet.

It is also possible to achieve a variety of effects by adjusting the density, brightness, saturation, color, and the like, in addition to the thickness of the second substrate 21.

In addition, in order to improve the visibility, the ink concentration of the first element 13 may be increased or the thickness of the ink may be increased.

In addition, the second element 23 may be thickened by screen printing or increased in density to reduce the exposure of the first element 13 and 14.

That is, when the printing method of each of the first elements 13 and 14 and the printing method of the second element 23 are applied differently, it is possible to obtain effects of a variety of combinations.

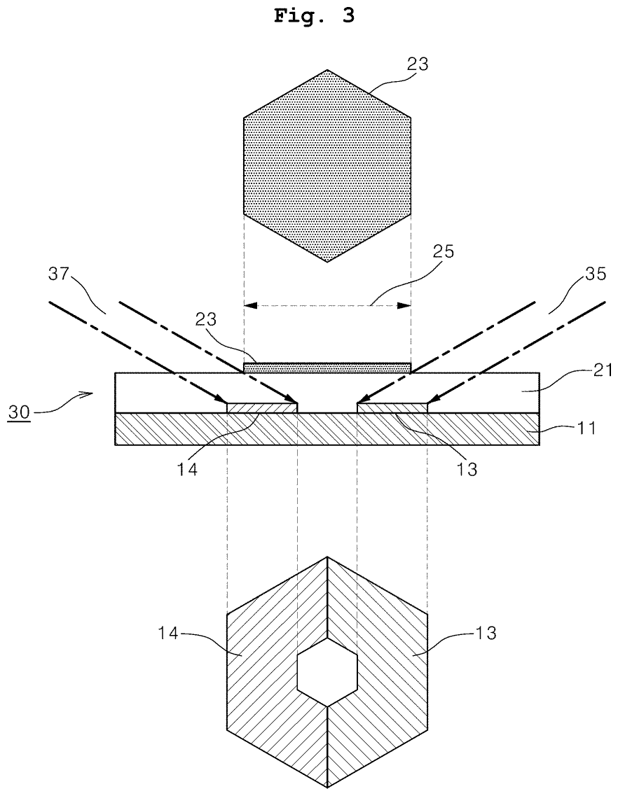

FIG. 3 is a view showing a cross section and a plane of an anti-counterfeiting sheet 30 utilizing visual characteristics according to a viewing angle, direction and distance according to another embodiment of the present invention.

FIG. 3 differs from FIG. 2 in that the first element printed on the first substrate 11 is composed (designed or printed) of sub-elements 13 and 14 of two colors.

For example, in the case that the first element is composed of a red sub-element 14 and a blue sub-element 13, upon recognizing the first element at a specific viewing angle, the red sub-element 14 is seen when viewed from the left side at a viewing angle 37, and the blue sub-element 13 is seen when viewed from the right side at a viewing angle 35.

Therefore, when the first element is divided into sub-elements 13 and 14 and designed to be a different color in each specific direction, different colors may be seen in each specific direction. In the present embodiment, the first element is designed in terms of two directions of left/right, but the present invention is not limited thereto, and the first element may be designed to be divided in terms of several directions. For example, the first element may be configured to be seen as different colors in the up/down directions, and may be also configured to be seen different colors in the up/down/left/right directions.

That is, in forming the first elements 13 and 14, color shift effects may be achieved by using general inks without using special inks such as expensive time-varying ink or color shift ink.

In addition, when fluorescent ink is used for the first elements 13 and 14, it is possible to obtain a stronger anti-counterfeiting effect with fluorescent latent image and color shift effects according to a viewing angle. For example, a fluorescent ink may be used alone, or a fluorescent material may be mixed with a general ink, such as composing two layers of a general ink layer and a fluorescent ink layer in an overlay printing manner.

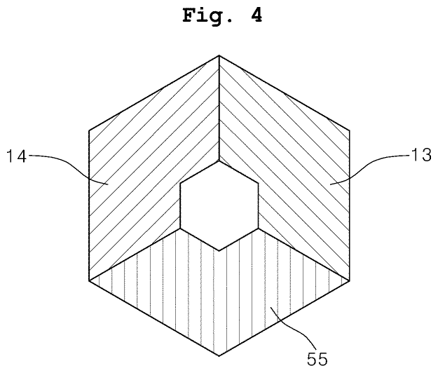

FIG. 4 is a plan view of a first element printed on an anti-counterfeiting sheet utilizing visibility characteristics according to a viewing angle, direction, and distance according to another embodiment of the present invention. Referring to FIG. 4, the first element is designed in such a manner as to be composed of three sub-elements 13, 14, and 55 and seen as different colors in three directions.

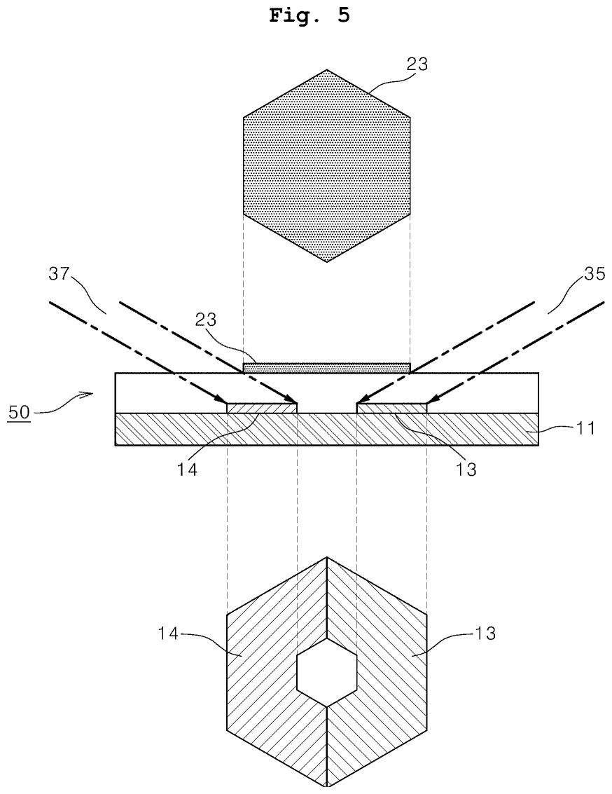

FIG. 5 is a view showing a cross section and a plane of an anti-counterfeiting sheet 20 utilizing visual characteristics according to a viewing angle, direction, and distance according to another embodiment of the present invention.

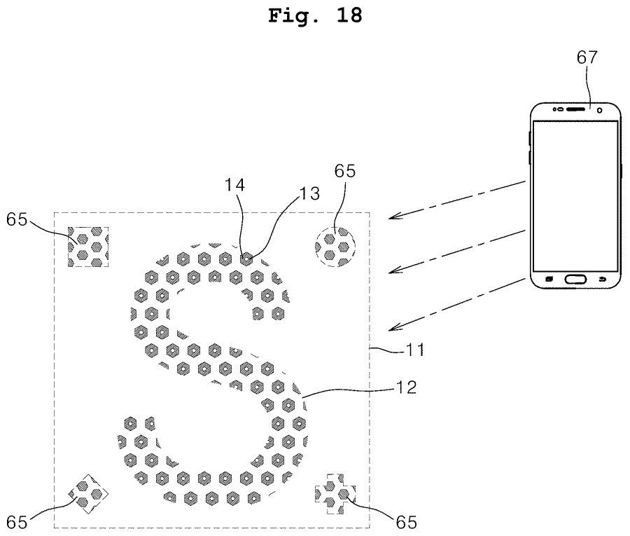

In FIG. 5, the pattern width 15 of the first element 13 is smaller than the pattern width 25 of the second element 23, compared to FIGS. 1 and 2. That is, the case in FIG. 5 is opposite to the case of FIG. 2. The reason for this is to make the latent image (or the first element 13 or the first pattern 12 (see FIGS. 13 and 18) completely invisible when the anti-counterfeiting sheet 20 is viewed in a vertical direction.

When the pattern width 15 of the first element 13 is equal to or larger than the pattern width 25 of the second element 23, the latent image is exposed immediately when the anti-counterfeiting sheet 20 is viewed to be slightly tilted from the vertical direction. Therefore, the embodiment in FIG. 5 may be used to prevent such a case.

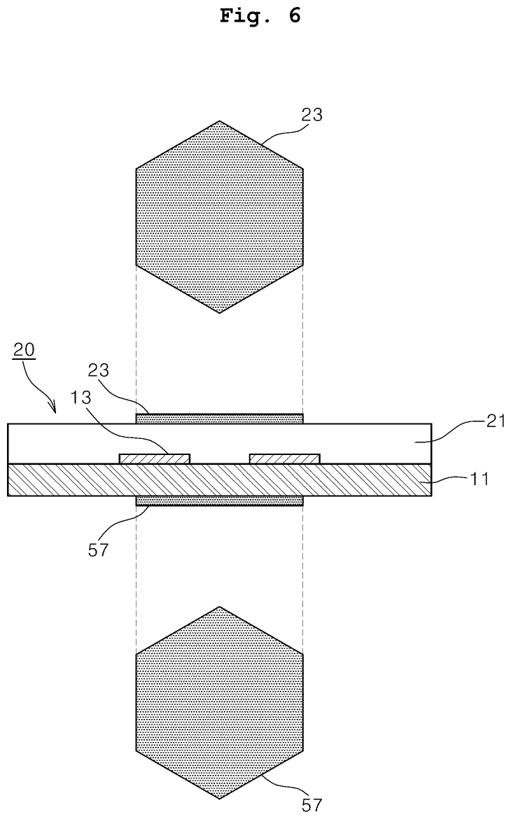

FIG. 6 is a view illustrating a cross section and a plane of an anti-counterfeiting sheet utilizing visibility characteristics according to a viewing angle, direction, and distance according to another embodiment of the present invention.

FIG. 6 differs from FIG. 2 in that a third element 57 is additionally formed and printed on the other surface of the first substrate 11, that is, on the other surface opposite to the printed surface of the first element 13.

The third element 57 may be polygonal or circular in shape and may be formed with a third pattern (not shown). That is, the third pattern may be configured to be arranged with a plurality of third elements 57 and third blanks (not shown).

The third element 57 may be designed and configured with the same purpose as the second element 23 described with reference to FIG. 1. In addition, the third element 57 may have the same characteristics as the second element 23.

With this configuration, it is possible to utilize the visual characteristics according to the viewing angle, direction, and distance on both sides of the anti-counterfeiting sheet.

For example, the anti-counterfeiting sheet 20 of FIG. 6 may be applied to a security window (security window) that is frequently used for the purpose of an anti-counterfeiting effect of money. That is, when both the first substrate 11 and the second substrate 21 are made of transparent substrates, the same effect may be obtained on both sides of the anti-counterfeiting sheet.

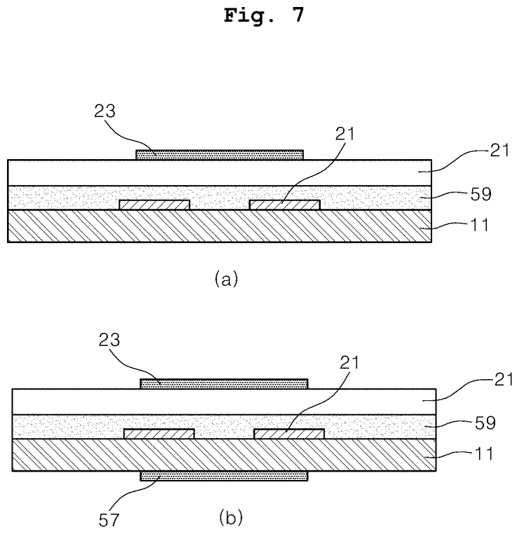

FIG. 7 is a cross-sectional view of an anti-counterfeiting sheet utilizing visual characteristics according to a viewing angle, direction and distance according to another embodiment of the present invention.

FIG. 7 differs from FIG. 2 or 6, in that an adhesive layer 59 is further formed between the first substrate 11 and the second substrate 21.

The second substrate 21 may be used by thermally compressing a coating layer or a film, but an adhesive is required for the lamination with the first substrate 11 when the second substrate is a material without an adhesive component.

Thus, the anti-counterfeiting sheet of FIG. 7 shows an example in which the adhesive layer 59 is formed when laminating the second substrate 21 on the first substrate 11 using an adhesive. In this case, the adhesive is preferably an adhesive of a transparent material, but the present invention is not necessarily limited thereto.

When an adhesive with low light transmittance is used, there is an effect that authenticity may be identified by lighting up the anti-counterfeiting sheet.

FIG. 7(a) is a case where the adhesive layer 59 is added to the anti-counterfeiting sheet of FIG. 2, FIG. 7(b) is a case where the adhesive layer 59 is added to the anti-counterfeiting sheet of FIG. 6. When the adhesive layer 59 is included, the thickness of the anti-counterfeiting sheet may be substantially increased, and therefore, such a case is recommended to be taken into account for the thickness control of the anti-counterfeiting sheet.

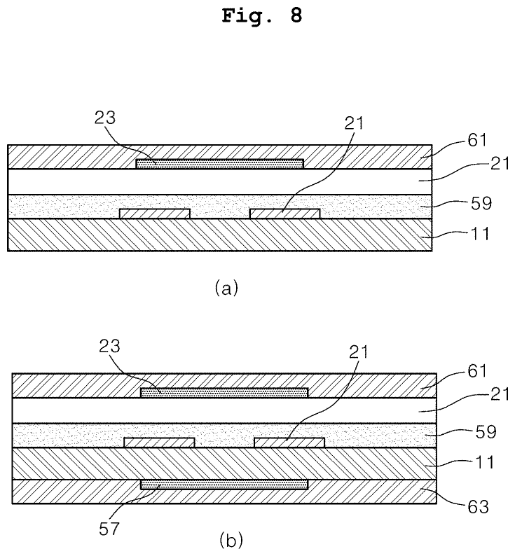

FIG. 8 is a cross-sectional view of an anti-counterfeiting sheet using visual characteristics according to a viewing angle, direction and distance according to another embodiment of the present invention.

FIG. 8 differs from FIG. 7, in that protective layers 61 and 63 are formed on one side or both sides of the anti-counterfeiting sheet.

The protective layers 61 and 63 are formed on the exposure surface of the first substrate 11 or the second substrate 21, respectively, as functional coating layers that are to protect the damage of the printed pattern exposed to the outside and increase the recognition or anti-counterfeiting effect.

FIG. 8(a) is a case in which the protective layer 61 is added to one surface of the anti-counterfeiting sheet of FIG. 7(a), and FIG. 7(b) is a case in which the protective layers 61 and 63 are added to both sides of the anti-counterfeiting sheet.

In addition, the protective layers 61 and 63 may be used as an additional anti-counterfeiting layer, and a layer of the deposited form may be applied, or a pearl ink layer of high reflectivity may be applied. The protective layers 61 and 63 may prevent an accurate image from being obtained in the case of duplication or forge via copying or scanning.

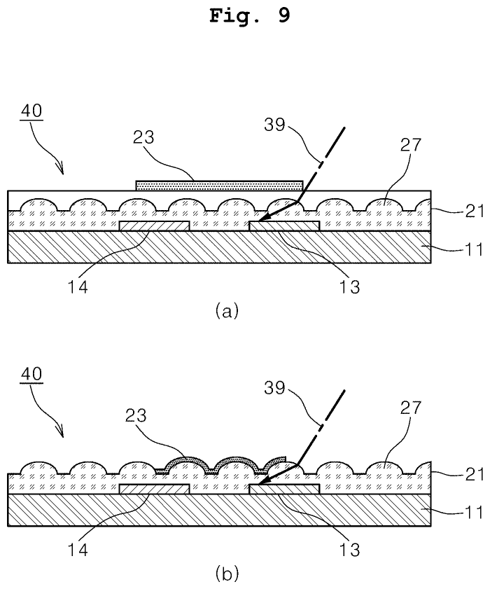

FIG. 9 is a cross-sectional view of an anti-counterfeiting sheet 40 utilizing visual characteristics according to a viewing angle, direction and distance, according to another embodiment of the present invention.

In FIG. 9, the second substrate 21 is different from FIGS. 1 to 3, in material.

The second substrate 21 shown in FIG. 9 may be an example (a) in which a film having embossed areas 27 formed therein is used or an example (b) in which a film having embossed areas 27 formed on a surface thereof is used.

The embossed areas 27 make the first element 13 be more visually recognized at a viewing direction 39 of a viewer due to refraction at the embossed surface. That is, there is an effect that the visibility is increased by increasing the viewing angle.

FIG. 9(b) is an example in which a film having embossed areas 27 formed on a surface thereof is used, in which the second element 23 or the second pattern 22 may be printed on surfaces of the embossed areas 27.

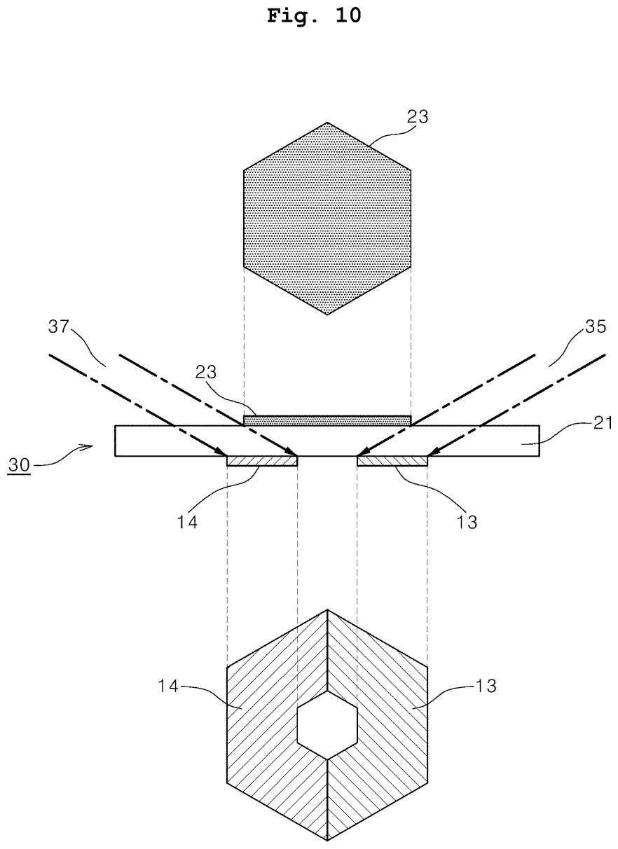

FIG. 10 is a view showing a cross section and a plane of an anti-counterfeiting sheet 50 utilizing visual characteristics according to a viewing angle, direction and distance according to another preferred embodiment of the present invention.

FIG. 10 differs from FIG. 3, in that the first elements 13 and 14 formed in the first substrate 11 are formed on one surface of the transparent substrate (second substrate) 21 without using the first substrate 11. In other words, double-sided printing or deposition is performed on the transparent substrate 21.

With respect to a case in which the first element 13 and 14 are formed on the first substrate 11 and the second element 23 is formed on the transparent substrate 21 as shown in FIG. 3, there is a difficulty in precisely matching the coordinates (positions) of the first and second elements in order to indicate the visual characteristics to be described with reference to FIGS. 13 to 16. That is, when the coordinates of the first and second elements formed on different substrates from each other are not precisely matched, a problem may arise in that the visual characteristics are changed according to the predetermined viewing angle, direction, and distance.

Therefore, in order to solve this problem, when the first and second elements are printed or deposited on both sides of the transparent substrate 21 without using the first substrate 11, the first and second elements may be more easily matched, and as a result, the same effects as in FIG. 3 may be obtained.

In the drawing, although the transparent substrate (second substrate) 21 is shown as one transparent layer, various substrates having light transmittances different from each other may be configured in such a manner as to form several layers.

In addition, on one or both surfaces of the anti-counterfeiting sheet 50, a special effect layer, such as one or more protective layer or hologram may be formed.

In addition, since the transparent substrate 21 is used, when the protective layer or the special effect layer to be added is a substrate having a predetermined light transmittance, it is possible to obtain a security window effect.

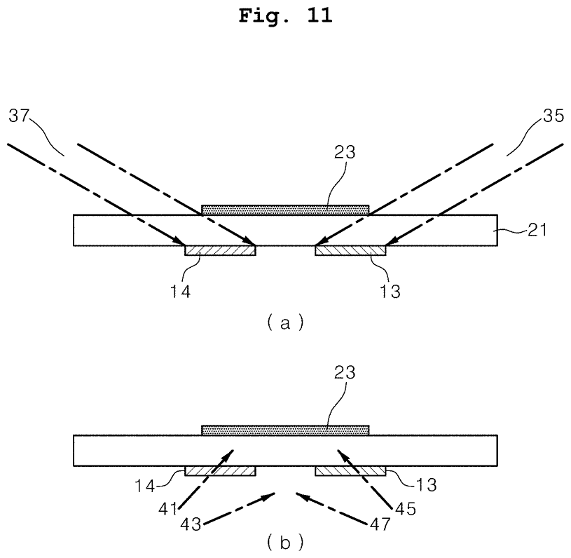

FIG. 11 is a view showing visual characteristics from both sides of an anti-counterfeiting sheet utilizing visual characteristics according to a viewing angle, direction, and distance according to another preferred embodiment of the present invention.

FIG. 11(a) is to describe the visual characteristics of the anti-counterfeiting sheet 50 of FIG. 10, which is the same as the visual characteristics of FIG. 3. That is, when the first element is composed of the red sub-element 14 and the blue sub-element 13 and viewed at a specific viewing angle, the red sub-element 14 is shown when viewed from the left at an angle 37, and the blue sub-element 13 is visible when viewed from the right at an angle 35.

Herein, referring to FIG. 11(b), the visual characteristics are different from that of FIG. 3.

In the case that the anti-counterfeiting sheet 50 is viewed from the bottom left, when the blue sub-element 13 is viewed at a viewing angle 43, the blue is seen, on the other hand, when the red sub-element 14 is viewed at a viewing angle 41, the red is unusually mixed with the color of the second element 23 and then darkened thereby making it look different in color. This is because the color of the second element 23 passes through the transparent substrate 21 and appears between particles of the sub-element 14, so that two colors are mixed.

As an example, in the case that the color of the second element 23 is white, when the anti-counterfeiting sheet 50 is viewed from the bottom left at angles 41 and 43, a color shift occurs in which a color close to blue is shown because blue, red, and white are mixed.

On the contrary, in the case that the anti-counterfeiting sheet 50 is viewed from the bottom right, when the red sub-element 14 is viewed at a viewing angle 47, the red is seen. Meanwhile when the blue sub-element 13 is viewed at a viewing angle 45, the blue is unusually mixed with the color of the second element 23 and then darkened thereby making it look different in color.

As an example, when the color of the second element 23 is white, when the anti-counterfeiting sheet 50 is viewed from the bottom right at angles 45 and 47, a color shift occurs in which a color close to red is shown because blue, red, and white are mixed.

Summarizing the above characteristics, there is a unique effect that when the anti-counterfeiting sheet 50 is viewed from the top left, the red is seen, and when the anti-counterfeiting sheet 50 is viewed from the top right, the blue is seen. Meanwhile when the anti-counterfeiting sheet 50 is viewed from the bottom left, the color similar to blue is seen, and when the anti-counterfeiting sheet 50 is viewed from the bottom right, the color similar to red is seen.

In addition, in the above-described embodiment, when the color of the second element 23 is other than white, it is possible to obtain an effect of converting to a completely different color other than red or blue when viewed from the bottom.

As described above, the first and second patterns composed of a plurality of elements and blanks are formed on both surfaces of the transparent substrate (second substrate) 21 and are to be visually recognized through the blanks, such that, by means of an optical illusion according to a viewing angle, direction, and distance, the resolution of the patterns changes or the colors thereof change, or patterns develop or a pattern shift occurs, on the basis of various combination of size, regularity, the number of each of the elements 13, 14, and 23 and the blanks 16 and 26, color, ink thickness, saturation, and brightness of each of the elements 13, 24 and 24, and thickness and density of the transparent substrate 21.

In addition, when the pattern or element is formed on the substrate, the above-described effects can be adjusted by using a printing or deposition method. When performing printing by applying the ink, the color of the second element 23 is seen a lot between the ink particles, meanwhile when performing deposition using finer metal component particles, the above effect is not available. Therefore, the printing method can be used in order to maximize the security window effect, and the deposition method can be used in order to maximize the latent image effect.

In addition, when screen printing is used, the thickness of the ink is increased, whereby the latent image and color shift effects can be increased.

In addition, each of the elements 13, 24, and 23 may obtain various combinations of effects by applying different types of printing or deposition methods.

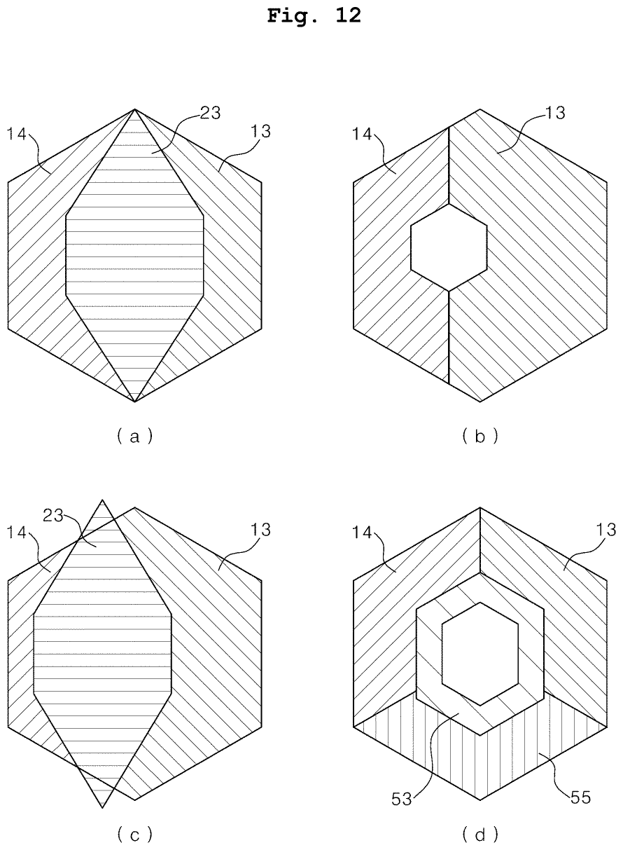

FIG. 12 shows plan views of various modified embodiments of the first and second elements.

Referring to FIG. 12(a), the second element 23 of FIG. 3 is elongated vertically. This embodiment is to prevent reduction of the effect due to a case that visually recognizes the upper and lower parts of the first element 14 and 13 while visually recognizing the first element 14 and 13 from the left and right. That is, since the upper and lower parts of the first element 14 and 13 are hidden by the elongated portion of the second element 23, the left and right visual characteristics may be enhanced.

In addition, when making the color of the first element 14 and the color of the second element 23 the same and the color of the first element 13 different, the color shift may occur only when viewed from the right side.

Referring FIGS. 12(b) and 12(c), the center blank of the first elements 14 and 13 is biased to the left, and the sizes of the red sub-element 14 and the blue sub-element 13 are asymmetrical. The first element 23 is also biased to the left. This embodiment has the effect of making left and right visibility characteristics asymmetrical.

FIG. 12(d) shows that a hexagonal ring 53 is added in the center of the embodiment of FIG. 4. Then, this embodiment obtains an effect as if the first pattern is moving, because the sub-elements 13, 14, and 55 and the hexagonal ring 53 are seen in succession when changing the viewing angle on the anti-counterfeiting sheet 50.

As described above, when the first and second elements are controlled to include sub-elements of different colors or different shapes, a wide variety of visual characteristics may be obtained, but the present invention is not limited to the above embodiments, and various variations and combinations are possible.

FIG. 13 is a plan view showing an anti-counterfeiting sheet utilizing visual characteristics according to a viewing angle, direction and distance according to another embodiment of the present invention. In FIG. 13, an embodiment in which the first elements 13 and 14 and the second element 23 described with reference to FIG. 3 are applied to actual patterns will be illustrated.

Referring to FIG. 13, a second pattern (honeycomb shape) 22 printed on the second substrate 21 and a plurality of second elements 23 and second blanks 26 constituting the second pattern 22 are shown in FIG. 13(a), and a first pattern (S letter) 12 printed on the first substrate 11 and a plurality of first elements 13 and 14 and first blank 16 constituting the first pattern 12 are shown in FIG. 13(b).

Referring to FIG. 13(a), a plurality of second elements 23 may form a second pattern 22 together with the blank 26. The second element 23 is regularly arranged in a honeycomb shape so that many patterns may be arranged per unit area, but the present invention is not necessarily limited thereto.

The reason why the plurality of second elements 23 are regularly arranged in a honeycomb shape together with the second blanks 26 is to allow the first elements 13 and 14 to be viewed at specific viewing angles 31, 33, 35, and 37 through the blanks 26 between the second elements 23 arranged in a honeycomb pattern. That is, the visual characteristics of the first pattern 12 are changed according to a specific viewing angle, direction, and distance through the second blank 26.

Referring to FIG. 13(b), a plurality of first elements 13 and 14 may form an S letter that is the first pattern 12 together with the blank 16. The first elements 13 are regularly arranged in a honeycomb shape like the second element 23 such that all or part of the first elements 13 is hidden (shielded) by the second elements 23, respectively. Considering the enlarged portion 53 of FIGS. 13(a) and 13(b), the first elements 13 and 14 and the second elements 23 are located in pairs up and down at the same position (coordinate) of the first substrate 11 and the second substrate 21 as shown in FIG. 3. That is, it is preferable that the enlarged portion 53 is formed up and down at the same position (coordinate) on the security paper sheet.

When the first and second elements are arranged as described above, when the anti-counterfeiting sheet 30 is viewed from above, the first patterns 12 and the first elements 13 are hardly exposed, and the first pattern 12 and the first elements 13 and 14 are partially exposed between the blank 26 of the second substrate 21 at specific viewing angles 31, 33, 35, and 37, as described above with reference to FIG. 3. In addition, since the first elements 13 and 14 are configured in different colors from each other, the first elements 13 and 14 are seen different in color in a specific direction.

Then, the visibility characteristics according to the distance will be described. While being viewed from the specific direction at the specific viewing angle as described above, the distance from the first pattern 12 is gradually increased. Then, the first elements 13 and 14 separated from each other are brought together and seen as one. This is due to the optical illusion over distance.

As the distance from the first pattern (S letter shape) 12 gets further and thus closer to the specific distance, the first elements separated from each other are seen as one. That is, the S-letter is not recognized when viewed nearby. However, the closer to the specific distance, the better the S-letter is recognized, whereby the S letter shape becomes clearer as the first elements separated from each other are seen to be merged. In addition, a difference in resolution of the pattern may occur depending on the distance between the patterns (first and second elements), the pitch of the pattern, the width of the pattern, the size of the pattern, the regularity of the pattern, and the number of patterns.

When the size of the blank 16 is increased, it is possible to maintain the effect of making longer the specific distance by which the first elements are seen to be merged, or of making the first elements seen to be separated apart. On the other hand, when the size of the blank 16 is reduced, the specific distance by which the first elements are merged is shorter. In addition, some areas of the first pattern 12 may be designed so as not to have the blank 16.

In addition, using the example of FIG. 9 may further improve the sharpness of the image.

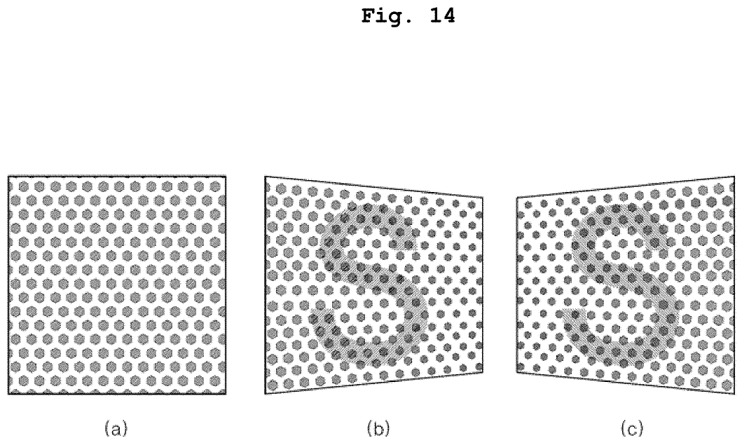

Referring to FIG. 14(a), the anti-counterfeiting sheet of FIG. 13 is visually recognized in a vertical direction, in which the first pattern (S letter shape) is almost or completely hidden and thus is not visually recognized.

Referring to FIG. 14(b), it is shown that the anti-counterfeiting sheet 30 is visually recognized in the left direction, at a specific angle, and a specific distance away, in which it is understood that the first red pattern (S letter) 12 is recognized.

Referring to FIG. 14(c), it is shown that the anti-counterfeiting sheet 30 is visually recognized in the right direction, at a specific angle, and a specific distance away, in which the first blue pattern (S letter) 12 is recognized instead of the first red pattern (S letter) 12.

In addition, the above-described embodiment is applied to the third element 57 of the anti-counterfeiting sheet according to the embodiments of FIGS. 6, 7(b), and 8(b) to achieve the same effect. That is, the above-described effects can be obtained in both surface directions of the anti-counterfeiting sheet through a third pattern (not shown) including the third element 37 and the blank.

In addition, the color shift and latent image effects on both sides can be obtained using the embodiment of FIG. 10.

As seen in this embodiment, the anti-counterfeiting sheet according to the present invention may have characteristics that the resolution of the patterns changes, the colors thereof change, or the patterns develop according to a specific viewing angle, direction, and distance.

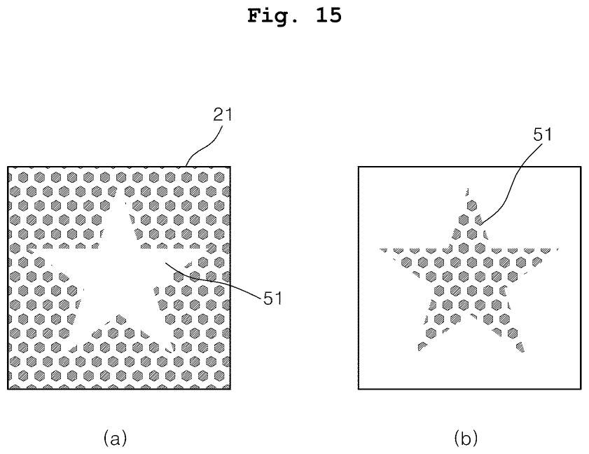

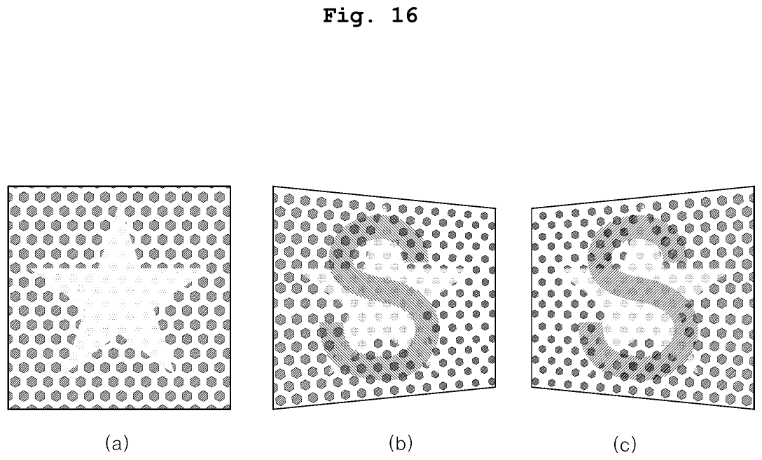

FIGS. 15 and 16 are views showing the anti-counterfeiting sheet is visually recognized at a specific viewing angle, direction, and distance according to another embodiment of the present invention.

FIG. 15 differs from with FIG. 13, in that a star-shaped second pattern 51 is illustrated on the second substrate 21. That is, the second patterns 22 and 51 may be printed using a plurality of inks having different reflectances from each other.

In the second pattern 51 of the present embodiment, a pearl ink having high reflectance is applied. In other words, the general ink is used in the portion other than a star in FIG. 15(a), and the ink having high reflectance is applied to the star portion in FIG. 15(b), whereby the star is exposed according to the viewing angle.

Referring to FIG. 16(a), it is seen that the second pattern (star) 51 appears at a specific viewing angle. That is, the star shape 51 to which the ink with high reflectance is applied is recognized to be close to white.

In addition, referring to FIG. 16(b), the anti-counterfeiting sheet is visually recognized in the left direction, at a specific angle, and a specific distance away, in which the second pattern (star shape) 51 is seen blurred, and the first red pattern (S letter) 12 is clearly recognized.

In addition, referring to FIG. 16(c), the anti-counterfeiting sheet is visually recognized in the right direction, at a specific angle, and a specific distance away, in which the second pattern (star shape) 51 is seen blurred, and the first red pattern (S letter) 12 is clearly recognized instead of the first red pattern (S letter) 12.

As can be seen in this embodiment, the anti-counterfeiting sheet according to the present invention has characteristics that the resolution of the patterns changes or the color thereof changes, or the patterns develop or a pattern shift occurs according to a specific viewing angle, direction, and distance.

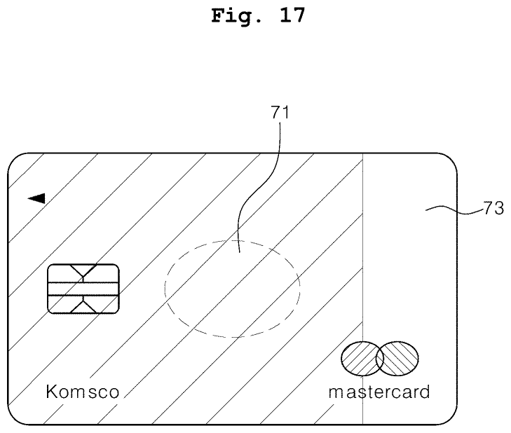

FIG. 17 is a view showing that the anti-counterfeiting sheet according to the present invention is applied to the credit card.

Referring to FIG. 17, the embodiment of FIG. 3 may be applied to the opaque region 71. In the configuration of FIG. 3, the first substrate 11 uses an opaque material, the second element 23 is formed to include a surface pattern of a credit card together with second blank 26, and the first elements 14 and 13 uses red and blue sub-elements.

Then, no latent image effect or color shift effect occurs on a back side of the card, but the first elements 14 and 13 are seen in the second blanks 26 through the transparent substrate 21 on the front side of the card, depending on a specific viewing angle, direction, and distance.

The transparent region 73 may implement a security window (security window) using the embodiment 50 of FIG. 10. That is, the security window effect occurs in the second blanks 26 through the transparent substrate 21 at a specific viewing angle, direction, and distance. In addition, the first elements 14 and 13 are visible in the second blank 26 through the transparent substrate 21 at another specific viewing angle, direction, and distance. Also, on the opposite side thereto, the second elements 23 are visible in the first blanks 16 through the transparent substrate 21.

A portion other than the transparent region 73, that is, the opaque region 71 may selectively block the security window effect through background printing that covers the first and second patterns of FIG. 10.

As described above, various embodiments of the anti-counterfeiting sheet according to the present invention can implement latent image and security window effects together with various effects. A credit card is exemplified in the present embodiment, but the present invention is not limited thereto and can be applied to polymer banknotes, security labels of transparent PET bottles, and the like.

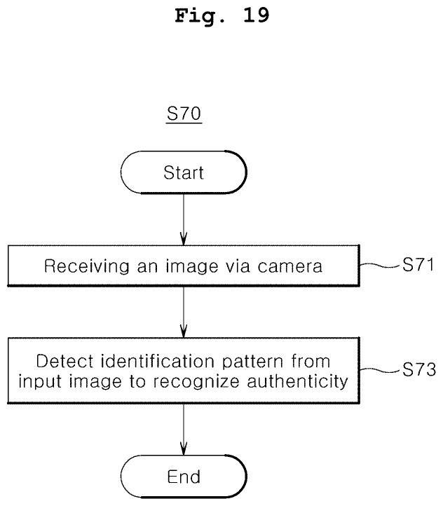

FIGS. 18 and 19 are a diagram and a flowchart showing a method of recognizing authenticity of the anti-counterfeiting sheet with a user terminal 67, according to another embodiment of the present invention.

Referring to FIG. 18, one or more identification patterns 65 are additionally designed and printed on the first substrate 11 as compared with FIG. 13(b). In addition, FIG. 18 shows that the anti-counterfeiting sheet is viewed or photographed at a specific viewing angle, direction, and distance with the user terminal (smartphone, etc.). The user terminal 67 may include a camera and an application (APP).

The identification pattern 65 may be formed to be overlapped with the forming area of the main pattern (the first pattern 12) or be formed in surrounding area other than the forming of the main pattern so as not to be identified by a user (the general public). Meanwhile, it is possible to form additional patterns of various forms (such as shapes, dots, lines, etc.) that may be identified through the identification device (smartphone 67, etc.). In addition, the identification pattern 65 may be made of a specific color designated in advance, or may be made of ink of a specific material.

Herein, the identification pattern 65 may include a fictional pattern that is printed as needed but does not have a predetermined functionality.

The identification pattern 65 may be used as recognition coordinates visually recognized at a predetermined viewing angle with the identification device 67, or may be used for further authenticity checking of an object, thereby enabling more accurate and effective authenticity check.

In the present embodiment, a smartphone has been exemplified as the identification device 67, but the present invention is not necessarily limited thereto. The identification device 67 may be various types of user terminals including a camera and a processor capable of driving an app or an application. For example, it may be a tablet or a notebook, or a PC to which a camera is connected.

Referring to FIG. 19, there is shown a flow chart S70 illustrating a method of recognizing authenticity of an anti-counterfeiting sheet according to another embodiment of the present invention using a user terminal.

In step S71, the App may receive an image by viewing or photographing the anti-counterfeiting sheet at a specific viewing angle, direction, and distance with a camera of the user terminal 67.

In step S73, the App may detect the identification pattern 65 from the input image. Here, the App may have information about the identification pattern 65 in advance. Then, by identifying the identification pattern 65, it is possible to recognize whether the identification pattern is present or the authenticity compared to the pre-stored identification pattern.

As described above, the anti-counterfeiting sheet according to the present invention may easily recognize the authenticity of the anti-counterfeiting sheet with the user terminal 67.

An embodiment of the authenticity recognition method described above may be implemented in the form of program instructions that may be executed through various computer components. In addition, the program implemented in the form of instructions may be recorded in a computer-readable recording medium. The mentioned recording medium may be a ROM, a magnetic disk or a compact disk, an optical disk, or the like, but the present invention is not necessarily limited thereto.

Hereinafter, a method of manufacturing an anti-counterfeiting sheet according to the present invention will be described.

The anti-counterfeiting sheet 50 of FIG. 10 is obtained by performing printing or depositing on both surfaces of a transparent substrate (second substrate) 21, in which the first pattern 12 is formed on one surface of the transparent substrate 21 and then the second pattern 22 is printed on the other surface thereof, and conversely, the second pattern 22 may be printed first. After the formation of the first and second patterns 12 and 22, an additional layer such as a background layer or a protective layer may be formed.

In addition, when the transparent substrate 21 is formed of several transparent layers, the transparent substrate 21 may be prepared before the first and second patterns 12 and 22 are formed.

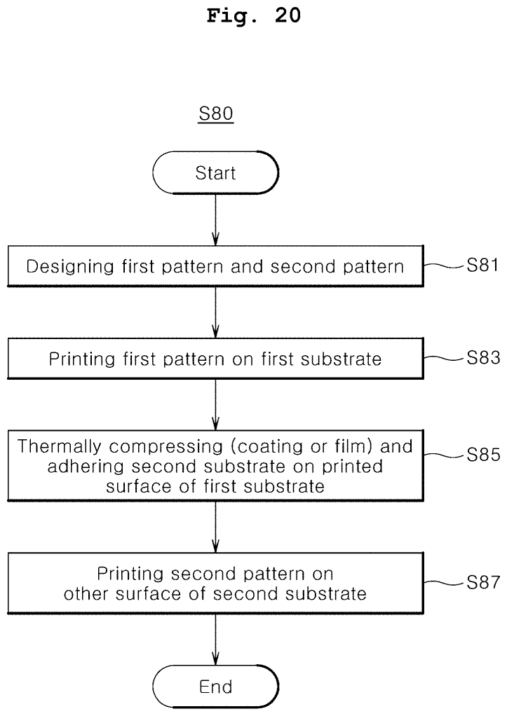

FIGS. 20 to 22 are flowcharts illustrating a method of manufacturing an anti-counterfeiting sheet utilizing visibility characteristics according to a viewing angle, direction, and distance, according to another embodiment of the present invention.

Referring to FIG. 20, in step S81, the first pattern 12 and the second pattern 22 may be designed by applying various embodiments described with reference to FIGS. 1 to 16. That is, multiple first elements 13 and 14, first blanks 16, second elements 23, and second blanks 26 are arranged to design the first pattern 12 and the second pattern 22, so that the resolution of the patterns changes or the colors thereof change, or the patterns develop or a pattern shift occurs according to a specific viewing angle, direction, and distance.

In step S83, the first pattern 12 may be printed on one surface of the first substrate 11. The ink used may be a special ink such as a color shift ink or a time varying ink, but a common general ink is enough. In addition, although a special printing process such as intaglio printing may be used, flat printing such as gravure, screen, flexo, offset, or inkjet is also enough.

In step S85, the second substrate (transparent substrate) 21 may be laminated by thermally compressing the coating layer or film on the printing surface of the first substrate 11.

Alternatively, as in the embodiments of FIGS. 7 and 8, the adhesive layer 59 may be formed by performing the lamination using an adhesive. As the adhesive, a typical adhesive may be used.

Preferably, the adhesive, the coating layer, and the film use a transparent material, and the film uses a polymer material, but the present invention is not necessarily limited thereto.

Using a thick adhesive or using a thick coating layer or film may increase the visibility of the first pattern 12 since the viewing range thereof is increased. In addition, there is an effect that the use of the film into which the embossed areas 27 is inserted increases the viewing angle.

In step S87, the second pattern 22 may be printed on the other surface of the second substrate 21 (a surface opposite to one surface in contact with the first substrate 11). It is preferable to use common inexpensive general ink, but the present invention is not necessarily limited thereto. For example, in order to realize the embodiment of FIG. 15, a pearl ink having a high reflectance may be used in combination.

The printing in the step S87 preferably makes it possible to have a cost reduction via a single process by performing the same flat printing as the step S83, but the present invention is not necessarily limited thereto.

In printing, as described with reference to FIGS. 1 to 3, it is preferable to perform precise printing through register matching so that a part or all of the first element 13 is hidden (shielded) by the second element 23.

The anti-counterfeiting sheet prepared through the above-described steps may have characteristics that the resolution of the patterns changes or the colors thereof change, or the patterns develop or a pattern shift occurs according to a specific viewing angle, direction, and distance.

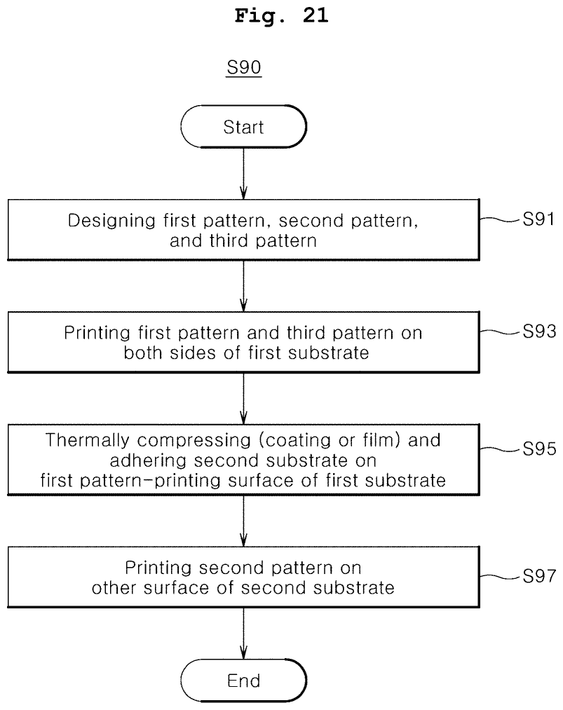

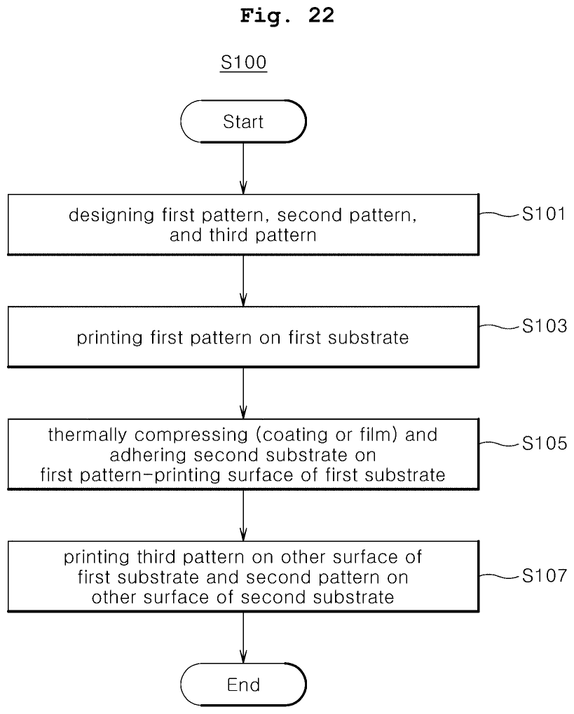

In addition, S90 illustrated in FIGS. 21 and S100 illustrated in FIG. 22 are flowcharts illustrating methods of manufacturing an anti-counterfeiting sheet in the case of further forming a third pattern (not shown) including a third element 57.

Referring to FIG. 21, in step S91, a third pattern composed of the third elements 57 may be further designed in comparison with S80.

In step S93, the first pattern 12 and the third pattern may be printed on both sides of the first substrate 11, respectively. Here, in order to obtain the visual effect in the side on which the third pattern is printed, it is preferable that the first substrate 11 use a transparent material.

In step S95, the lamination similar as in step S85 may be performed.

In step S97, the printing similar in step S87 may be performed.

FIG. 22 differs from FIG. 21, in that the printing S107 of the third pattern is performed after the lamination S105.

As described above, the first and second patterns are formed as a plurality of elements and blanks on both surfaces of the transparent substrate and are to be visually recognized through the blanks, such that, by means of an optical illusion according to a viewing angle, direction, and distance, the resolution of the patterns changes or the colors thereof change, or the patterns develop or a pattern shift occurs, on the basis of various combination of size, regularity, the number of each of the elements 13, 14, and 23 and the blanks 16 and 26, brightness, saturation, and color of each of the elements 13, 24 and 24, and thickness, density, brightness, saturation, and color of the transparent substrate 21.

According to the present invention, high anti-counterfeiting effects such as a color shift, a latent image, and a security window can be obtained without using an expensive special ink, carrying out a complicated printing process, or using a special material. In other words, it is possible to use inexpensive materials such as general ink, and perform manufacturing in a single process by using existing processes such as flat printing.

Therefore, the present invention is easy to use in low-cost product family or small quantity multi-product family. Applicable products may include security products such as cards, polymer banknotes, security labels, anti-copy paper, hidden lines, security windows, certificates, tags, and the like, and commercial products such as wallpaper, labels, wrapping paper, shrink films, and the like. In addition, the anti-counterfeiting sheet according to the present invention enables easy identification of the authenticity (level 1). That is, it is easy to identify the authenticity by carrying out photography at a specific viewing angle with a smartphone equipped with a camera without a need to have a specific temperature or a special light source. In addition, the use of fluorescent ink can obtain a stronger anti-counterfeiting effect with fluorescent latent image and color shift effects depending on the viewing angle. In addition, the security window effect according to the present invention can obtain a stronger anti-counterfeiting effect by easily adjusting the same or different colors visible on both sides.

As described above, the present invention has been described with reference to the embodiment shown in the drawings, but this is merely exemplary, and it will be appreciated that those skilled in the art can perform various modifications and equivalent embodiments. Therefore, the true technical protection scope of the present invention will be defined by the technical spirit of the appended claims.

1. An anti-counterfeiting sheet, comprising:
a transparent substrate having a first pattern formed on one surface and a second pattern formed on the other surface,
wherein the first pattern is configured to include a plurality of first elements and first blanks, and the second pattern is configured to include a plurality of second elements and second blanks; and
all or a part of the first element is hidden by the second element when the second element is viewed directly from above, and the first pattern is visually recognized at a predetermined viewing angle through the second blanks.

2. An anti-counterfeiting sheet, comprising:
a first substrate having a first pattern formed on one surface; and
a transparent substrate having one surface laminated with the one surface on which the first pattern of the first substrate is formed and the other surface on which a second pattern is formed,
wherein the first pattern is configured to include a plurality of first elements and first blanks, and the second pattern is configured to include a plurality of second elements and second blanks; and
all or a part of the first element is hidden by the second element when the second element is viewed directly from above, and the first pattern is visually recognized at a predetermined viewing angle through the second blanks.

3. The sheet of claim 2, further comprising:
a third pattern formed on the other surface opposite to the one surface on which the first pattern of the first substrate is formed,
wherein the third pattern is configured to include a plurality of third elements and third blanks, and the first pattern is visually recognized at a predetermined viewing angle through the third blanks.

4. The sheet of claim 1 or claim 2, wherein the plurality of first elements or second elements is regularly arranged.

5. The sheet of claim 1 or claim 2, wherein a resolution of the first pattern changes, a color thereof changes, the pattern develops, or a pattern shift occurs according to a viewing angle, direction, and distance.

6. The sheet of claim 1 or claim 2, wherein the transparent substrate is composed of one or more layers having a predetermined light transmittance.

7. The sheet of claim 1 or claim 2, wherein the first element includes sub-elements formed of different colors, different shapes, or different inks from each other.

8. The sheet of claim 1 or claim 2, wherein the plurality of second elements are formed using a plurality of inks having different amounts of reflectance from each other.

9. The sheet of claim 1 or claim 2, wherein the first pattern or second pattern is formed by a combination of any one or more of gravure printing, screen printing, flexographic printing, offset printing, inkjet printing, and deposition.

10. The sheet of claim 2, wherein the first substrate and the second substrate are laminated using an adhesive of a material having a predetermined light transmittance.

11. The sheet of claim 1 or claim 2, wherein embossed areas are formed on the transparent substrate.

12. The sheet of any one of claims 1 to 3, wherein a protective layer or a background layer is formed on one surface or both surfaces of the anti-counterfeiting sheet.

13. A method of recognizing authenticity of the anti-counterfeiting sheet according to claim 1 or claim 2 with a user terminal having an App and a camera, in which the first pattern is designed to include an identification pattern, the method comprising:
by the App, receiving an image of the anti-counterfeiting sheet through the camera; and
by the App, detecting the authenticity by detecting the identification pattern from the received image,
wherein the user terminal includes information about the identification pattern in advance.

14.-15. (canceled)

16. A method of manufacturing an anti-counterfeiting sheet, the method comprising:
forming a first pattern on one surface of a transparent substrate; and
forming a second pattern on the other surface of the transparent substrate,
wherein the first pattern is configured to include a plurality of first elements and first blanks, and the second pattern is configured to include a plurality of second elements and second blanks; and
all or a part of the first element is hidden by the second element when the second element is viewed directly from above, and the first pattern is visually recognized at a predetermined viewing angle through the second blanks.

17.-18. (canceled)
